(19) United States
(12) Patent Application Publication
(10) Pub. No.: US 2021/0300093 A1
(43) Pub. Date: Sep. 30, 2021

(54) INK-JET PRINTER

(71) Applicant: BROTHER KOGYO KABUSHIKI KAISHA, Nagoya-shi (JP)

(72) Inventors: Hikaru TAMURA, Okazaka-shi (JP); Tsuyoshi KUWAYAMA, Kasugai -shi (JP); Fumio NAKAZAWA, Okazaki -shi (JP); Yoshinori OSAKABE, Seto-shi (JP); Hirotaka AOKI, Nagoya-shi (JP)

(73) Assignee: BROTHER KOGYO KABUSHIKI KAISHA, Nagoya-shi (JP)

(21) Appl. No.: 17/203,280

(22) Filed: Mar. 16, 2021

(30) Foreign Application Priority Data
Mar. 26, 2020 (JP) 2020-056528

(51) Int. Cl. B41J 25/00; B41J 2/165

(52) U.S. Cl. CPC B41J 25/001; B41J 2/16505

(57) ABSTRACT

There is provided an ink-jet printer, including: a tray; a recording section including a carriage and a head; a reservoir; a tube; a platen; a first guide member arranged at a front side of the recording section in a front-rear direction and having a first curved surface configured to guide a first surface of the sheet; a discharge section configured to discharge the sheet from a rear side toward the front side in the front-rear direction, the discharge section being arranged at the rear side of the recording section; a second guide member arranged at the rear side of the recording section and having a second curved surface configured to guide the first surface of the sheet; and a loading section configured to load the sheet discharged from the discharge section thereon. The loading section includes an inclined portion at the rear side of the recording section, the inclined portion being inclined upward toward the front side of the discharge section. The tube passes through a specified space positioned at the front side of the recording section and is connected to the recording section.

### CROSS REFERENCE TO RELATED APPLICATION

The present application claims priority from Japanese Patent Application No. 2020-056528 filed on Mar. 26, 2020, the disclosure of which is incorporated herein by reference in its entirety.

### BACKGROUND

### Field of the Invention

The present disclosure is related to an ink-jet printer that is capable of recording an image by discharging ink droplets on a sheet.

### Description of the Related Art

There are known ink-jet printers that discharge a sheet on an upper surface of a casing. In a publicly-known ink-jet printer, a sheet is discharged rearward (backward). That is, the sheet is discharged in a direction away from a user in front of the ink-jet printer.

In the above ink-jet printer, a support surface that supports the sheet discharged is inclined upward with distance from a discharge opening (i.e., toward a rear portion of the printer). Thus, a part of a casing close to the discharge opening (front portion of the casing) has a low height, which makes an inside of the front portion of the casing narrow. A part of the casing far from the discharge opening (rear portion of the casing) has a height higher than the front portion of the casing, which makes the inside of the rear portion of the casing large.

### SUMMARY

A user typically takes out a sheet discharged from a front portion of an ink-jet printer. When taking out the sheet, the user holds a rear end of the sheet. In the above ink-jet printer, however, the sheet is discharged rearward (backward). The rear end of the sheet is thus farther from the user than a front end of the sheet, thereby making it difficult for the user to take out the sheet.

In the above ink-jet printer, a head for discharging ink droplets is connected to a reservoir for storing ink via a tube. The reservoir is typically arranged at the front portion of the casing. Since the inside of the front portion of the casing is narrow as described above, arrangement of the tube is difficult. The arrangement of the tube may thus increase the size of the casing.

The present disclosure is made in view of the above circumstances, and an object of the present disclosure is to provide an ink-jet printer that allows a user to easily take out a sheet and allows a tube to be arranged without the increase in size of a casing.

According to an aspect of the present disclosure, there is provided an ink-jet printer, including: a tray configured to support a sheet; a recording section including a carriage positioned above the tray and configured to move in a width direction orthogonal to an up-down direction and a front-rear direction, and a head carried on the carriage and including a nozzle configured to discharge an ink droplet; a reservoir configured to store an ink; a tube connecting the reservoir and the recording section; a platen located between the recording section and the tray in the up-down direction, and configured to support a first surface of the sheet that is conveyed, below the head, from a front side toward a rear side in the front-rear direction; a first guide member arranged at the front side of the recording section and including a first curved surface configured to guide the first surface of the sheet conveyed from the tray toward the platen; a discharge section configured to discharge the sheet having an image recorded by the recording section from the rear side toward the front side in the front-rear direction, the discharge section being arranged at the rear side of the recording section; a second guide member arranged at the rear side of the recording section and having a second curved surface configured to guide the first surface of the sheet conveyed from the platen toward the discharge section; and a loading section configured to load the sheet discharged from the discharge section thereon, at least a part of the loading section being positioned above the recording section. The loading section includes an inclined portion at the rear side of the recording section, the inclined portion being inclined upward toward the front side of the discharge section. The tube passes through a specified space positioned at the front side of the recording section and is connected to the recording section.

According to this configuration, the sheet is discharged from the rear side toward the front side in the front-rear direction. A leading end of the sheet is thus the front end of the sheet, which is close to a user positioned in front of the ink-jet printer. That is, the user can take out the discharged sheet easily.

According to this configuration, the inclined portion inclined upward toward the front side makes the space in which the recording section and the tube are arranged, larger in the up-down direction toward the front side. In this configuration, the tube is arranged to pass through the predefined space positioned at the front side of the recording section. It is thus possible to arrange the tube without the increase in size of the ink-jet printer.

According to the ink-jet printer of the present disclosure, the sheet can be taken out easily and the tube can be arranged without the increase in size of the casing.

### BRIEF DESCRIPTION OF THE DRAWINGS

FIG. 1 is a perspective view of a printer.

FIG. 2 is a longitudinal sectional view taken along a line II-II of FIG. 1.

FIG. 3 is a transverse sectional view taken along a line of FIG. 1.

FIG. 4 schematically depicts a configuration of a maintenance unit.

FIG. 5 is a transverse sectional view of a portion that corresponds to the cross-section taken along the line of FIG. 1 according to a modified embodiment.

FIG. 6 is a transverse sectional view of a portion that corresponds to the cross-section taken along the line of FIG. 1 according to another modified embodiment.

FIG. 7 is a transverse sectional view of a portion that corresponds to the cross-section taken along the line of FIG. 1 according to still another modified embodiment.

FIG. 8 is a perspective view of a printer according to a yet another modified embodiment.

FIG. 9 is a perspective view of a printer according to a further modified embodiment.

### DESCRIPTION OF THE EMBODIMENTS

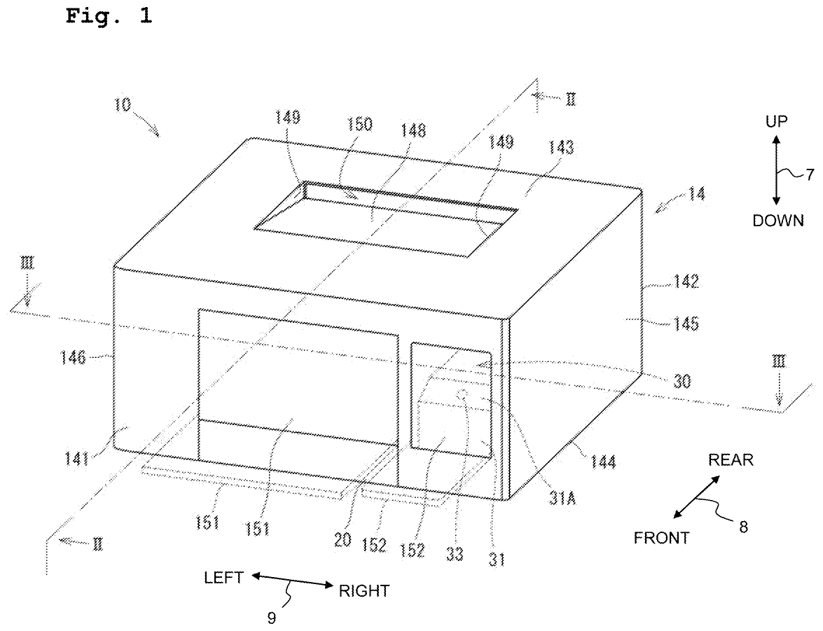

An embodiment of the present disclosure is described below. The embodiment described below is merely an example of the present disclosure and it is possible to make any appropriate change(s) in the embodiment of the present disclosure without departing from the gist and/or scope of the present disclosure. In the following explanation, an up-down direction 7 is defined based on a state where a printer 10 is arranged to be usable (the state depicted in FIG. 1). A front-rear direction 8 is defined as a surface provided with an opening/closing cover 151 is a front surface of the printer 10. A left-right direction 9 (an exemplary width direction) is defined as the printer 10 is viewed from the front side. The up-down direction 7, the front-rear direction 8, and the left-right direction 9 are orthogonal to each other. In this embodiment, the up-down direction 7 corresponds to a vertical direction, and the front-rear direction 8 and eth left-right direction 9 correspond to a horizontal direction.

<Schematic Configuration of Printer 10>

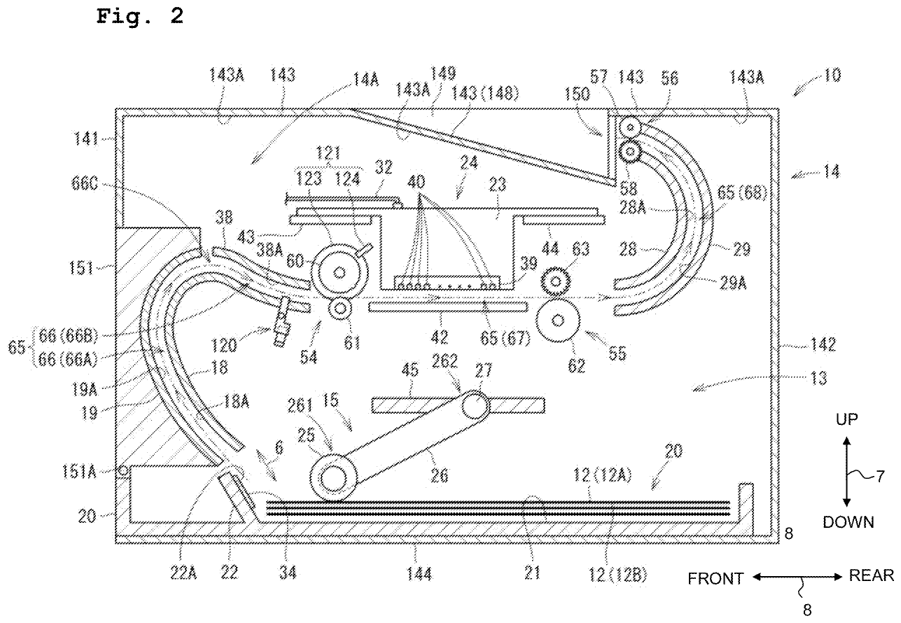

The printer 10 depicted in FIG. 1 (an exemplary ink-jet printer) has a function that records an image on a sheet 12 (an exemplary sheet, see FIG. 2) in accordance with an ink-jet recording system.

As depicted in FIG. 1, the printer 10 includes a casing 14 having a substantially rectangular parallelepiped shape. The casing 14 includes a front wall 141, a rear wall 142, an upper wall 143, a lower wall 144, a right wall 145, and a left wall 146. An internal space 13 of the casing 14 (see FIG. 2) is formed by the front wall 141, the rear wall 142, the upper wall 143, the lower wall 144, the right wall 145, and the left wall 146.

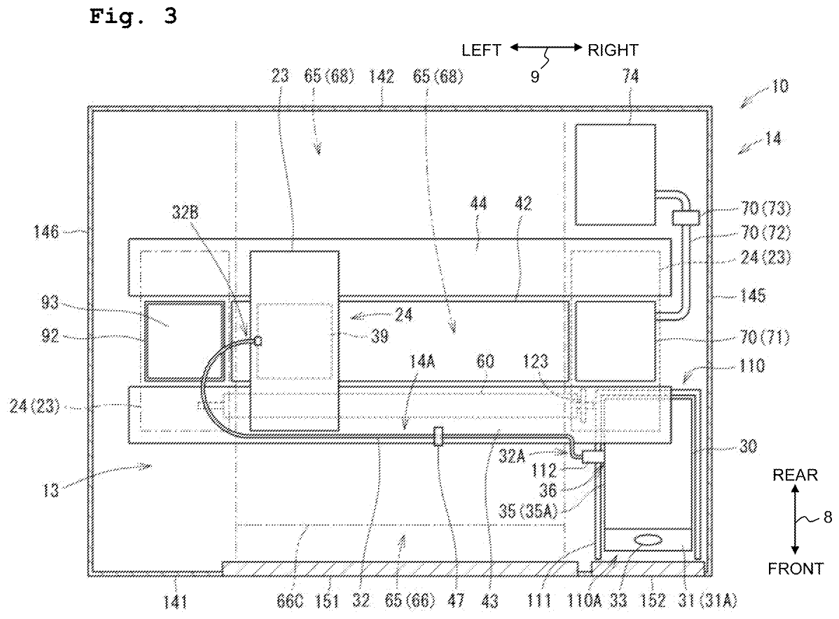

The upper wall 143 (an exemplary loading section) includes an inclined wall 148 (an exemplary inclined portion). The inclined wall 148 extends in the left-right direction 9 at least from a left end to a right end of a platen 42 (see FIGS. 2 and 3) described below. In FIG. 3, a conveyance route 65 through which the sheet 12 is conveyed corresponds to an area between two dot-dash chain lines in the left-right direction 9. That is, the conveyance route 65 is an area between the left end and the right end of the platen 42 in the left-right direction 9.

As depicted in FIGS. 1 and 2, the inclined wall 148 is inclined upward toward the front side. As depicted in FIG. 1, a pair of side walls 149 extends upward in a right end and a left end of the inclined wall 148. In the upper wall 143, any other part than the inclined wall 148 extends in the front-rear direction 8 and the left-right direction 9. Since a rear end of the inclined wall 148 is positioned on the lower side of any other part than the inclined wall 148 of the upper wall 143, there is a step (level difference) between the rear end of the inclined wall 148 and any other part than the inclined wall 148 of the upper wall 143. The step is formed having an opening 150 (an exemplary discharge section) facing frontward. The rear end of the inclined wall 148 and the opening 150 are positioned at the rear side of a recording section 24 described below. That is, at the rear side of the recording section 24, the inclined wall 148 is inclined upward from the opening 150 toward the front side.

As depicted in FIG. 2, the upper wall 143 forms an upper end of the internal space 13 of the casing 14. The upper wall 143 is positioned at the upper side of the recording section 24. Although the whole of the upper wall 143 is positioned at the upper side of the recording section 24 in this embodiment, a part of the upper wall 143 (e.g., a lower end of the inclined wall 148) may be positioned at the lower side of the recording section 24.

As depicted in FIG. 1, two opening/closing covers 151 and 152 are provided in the front wall 141.

The opening/closing cover 151 extends in the left-right direction 9 at least from the left end to the right end of the platen 42 (see, FIGS. 2 and 3). The opening/closing cover 151 is supported by the front wall 141 to be pivotable around a shaft 151A (see FIG. 2A) that extends in the left-right direction 9 at a lower end of the opening/closing cover 151. The opening/closing cover 151 is pivotable between a closed position indicated by solid lines in FIG. 1 and an open position indicated by broken lines in FIG. 1. As depicted in FIG. 2, a guide member 19 forming a first curved route 66 of the conveyance route 65 is attached to the opening/closing cover 151. That is, the guide member 19 pivots integrally with the opening/closing cover 151. The guide member 19 forms the first curved route 66 in a state where the opening/closing cover 151 is in the closed position. In this situation, a curved surface 18A of a guide member 18 described below is separated from the outside by being covered with the opening/closing cover 151. The first curved route 66 is exposed to the outside of the casing 14 in a state where the opening/closing cover 151 is in the open position. In this situation, the curved surface 18A is exposed to the outside. This allows a user to easily take out the sheet 12 jammed in the first curved route 66.

As depicted in FIG. 1, the opening/closing cover 152 is provided at the right side of the opening/closing cover 151, that is, at a right portion of the front wall 141. The opening/closing cover 152 is supported by the front wall 141 to be pivotable around a shaft that extends in the left-right direction 9 at a lower end of the opening/closing cover 152.

As depicted in FIG. 3, an installation section 110 is arranged at the rear side of the opening/closing cover 152. That is, the installation section 110 is provided at a right front portion of the internal space 13 of the casing 14. The installation section 110 is a box-like member of which front side is open. A tank 30 (an exemplary reservoir) described below is arranged in an internal space 110A of the installation section 110.

The opening/closing cover 152 is pivotable between a closed position indicated by solid lines in FIG. 1 and an open position indicated by broken lines in FIG. 1. In a state where the opening/closing cover 152 is in the closed position, the installation section 110 and the tank 30 are separated from the outside by being covered with the opening/closing cover 152. In a state where the opening/closing cover 152 is in the open position, the installation section 110 and the tank 30 are exposed to the outside.

As depicted in FIG. 2, the printer 10 includes a feed tray 20 (an exemplary tray), a feed section 15, a first conveyance roller pair 54, a second conveyance roller pair 55, a third conveyance roller pair 56, the recording section 24, the platen 42, a sensor 120, a rotary encoder 121, a maintenance unit 70, and an ink receiver 92. The feed section 15, the first conveyance roller pair 54, the second conveyance roller pair 55, the third conveyance roller pair 56, the recording section 24, the platen 42, the sensor 120, the rotary encoder 121, the maintenance unit 70, and the ink receiver 92 are arranged in the internal space 13 of the casing 14.

<Feed Tray 20>

The feed tray 20 depicted in FIG. 1 is inserted rearward to be installed in the casing 14 and is pulled out frontward to be removed from the casing 14 through an opening formed at the lower side of the opening/closing cover 151 in the front wall 141 of the casing 14.

As depicted in FIG. 2, the feed tray 20 has a box-like shape of which upper side is open. The feed tray 20 supports sheets 12 stacked on a bottom surface 21.

The feed tray 20 includes an inclined wall 22 that extends toward an obliquely upper frontward side from a front portion of the bottom surface 21 in a state where the feed tray 20 is installed in the casing 14. A separating section 34 is provided at a center portion in the left-right direction 9 of a rear surface 22A of the inclined wall 22. The separating section 34 has a function to separate the uppermost sheet 12 included in the sheets 12 brought into contact with the separating section 34, from remaining sheets 12 included in the sheets 12 brought into contact with the separating section 34. The separating section 34 has teeth arranged in an inclined direction 6 that is along the rear surface 22A and orthogonal to the left-right direction 9. The separating section 34 may have any other configuration than the configuration having the teeth, provided that the function can be achieved. For example, when a friction coefficient of the separating section 34 is larger than a friction coefficient of the inclined wall 22, the separating section 34 can have a function to separate the uppermost sheet 12 included in the sheets 12 brought into contact with the separating section 34, from remaining sheets 12 included in the sheets 12 brought into contact with the separating section 34. For example, the separating section 34 may include a cork instead of the teeth.

<Feed Section 15>

As depicted in FIG. 2, the feed section 15 includes a feed roller 25, a feed arm 26, and a shaft 27.

The feed roller 25 is rotatably supported by a front end 261 of the feed arm 26. When the sheet 12 is supported by the feed tray 20, the feed roller 25 comes into contact with the sheet 12 from above. When no sheet 12 is supported by the feed tray 20, the feed roller 25 comes into contact with the bottom surface 21 of the feed tray 20 from above.

A base end 262 of the feed arm 26 is pivotally supported around the shaft 27 by a frame 45 of the printer 10. The base end 262 is positioned at the rear side and the upper side of the front end 261.

The feed roller 25 rotates upon receiving driving force from a motor (not depicted). This causes the feed roller 25 to convey the sheet 12 supported by the feed tray 20 frontward, feeding the sheet 12 to the first curved route 66 of the conveyance route 65.

A leading end(s) of the sheet(s) 12 fed by the feed roller 25 come(s) into contact with the teeth of the separating section 34. When the leading ends of the sheets 12 come into contact with the teeth of the separating section 34, the separating section 34 separates the uppermost sheet 12 included in the sheets 12 coming into contact with the feed roller 25 from remaining sheets 12 included in the sheets 12 coming into contact with the feed roller 25. Thus, only the uppermost sheet 12 is fed to the first curved route 66.

The sheet 12 fed to the conveyance route 65 is conveyed in a conveyance orientation 16 along the conveyance route 65. The conveyance orientation 16, which is a direction along the conveyance route 65, is indicated by a dot-dash chain line in FIG. 2. The sheet 12 conveyed by the feed roller 25 in the conveyance orientation 16 heads toward the first conveyance roller pair 54 positioned in the conveyance route 65.

<Conveyance Route 65>

As depicted in FIG. 2, the internal space 13 of the casing 14 is formed having the conveyance route 65 through which the sheet 12 passes. The conveyance route 65 includes a space formed by the guide members 18 and 19 facing each other at a predefined interval, a space formed by the recording section 24 and the platen 42, and a space formed by the guide members 28 and 29 facing each other at a predefined interval.

The conveyance route 65 is formed by the first curved route 66, an extending route 67 extending linearly, and a second curved route 68.

The first curved route 66 is formed at a front portion of the internal space 13 of the casing 14. The first curved route 66 ranges from a front end of the feed tray 20 to the first conveyance roller pair 54. The first curved route 66 is formed by the guide member 18 (an exemplary first guide member) and the guide members 19, 38 facing each other at the predefined interval.

The guide member 18 is arranged at the front side of the recording section 24. The guide member 18 has the curved surface 18A (an exemplary first curved surface) curved to be convex frontward. The guide member 19 is arranged at the front side of the guide member 18. The guide member 19 has a curved surface 19A curved to be concave frontward. The guide member 38 is positioned above the guide member 18 at a position between the guide member 19 and the recording section 24. The guide member 38 has a curved surface 38A extending downward toward the rear side.

The curved surface 18A guides a first surface 12A of the sheet 12 conveyed from the feed tray 20 toward the first conveyance roller pair 54. The curved surfaces 19A and 38A guide a second surface 12B of the sheet 12 conveyed from the feed tray 20 toward the first conveyance roller pair 54. The first surface 12A of the sheet 12 faces upward in a state where the sheet 12 is supported by the feed tray 20. The first surface 12A of the sheet 12 faces the platen 42 and is supported by the platen 42 in a state where the sheet 12 is positioned between the recording section 24 and the platen 42. The second surface 12B of the sheet 12 faces downward in the state where the sheet 12 is supported by the feed tray 20. The second surface 12B of the sheet 12 faces the recording section 24 and ink droplets are discharged on the second surface 12B, in the state where the sheet 12 is positioned between the recording section 24 and the platen 42.

The first curved route 66 has a first route 66A and a second route 66B. The first route 66A extends frontward and upward from the front end of the feed tray 20 and makes a U-turn from the front side toward the rear side. The first route 66A is formed by the guide members 18 and 19. A first end of the first route 66A leads to or is connected to the front end of the feed tray 20. This allows the feed roller 25 to feed the sheet 12 supported by the bottom surface 21 of the feed tray 20 to the first route 66A. A second end of the first route 66A leads to or is connected to the second route 66B. The second route 66B extends downward from the second end of the first route 66A toward the rear side. The second route 66B is formed by the guide members 18 and 38. A first end of the second route 66B leads to or is connected to the second end of the first route 66A. A boundary between the first route 66A and the second route 66B is an upper end 66C of the first curved route 66. A second end of the second route 66B leads to or is connected to a front end of the extending route 67.

The extending route 67 is formed at a center portion of the internal space 13 of the casing 14. The extending route 67 is positioned above the feed tray 20. The extending route 67 faces a lower surface 143A of the upper wall 143 of the casing 14 in the up-down direction 7. The extending route 67 is formed by the recording section 24 and the platen 42. The extending route 67 extends rearward from the second end of the first curved route 66, passes through the first conveyance roller pair 54 and the recording section 24 in this order, and reaches the second conveyance roller pair 55. The front end of the extending route 67 leads to or is connected to the second end of the first curved route 66 as described above. A rear end of the extending route 67 leads to or is connected to the second curved route 68.

The second curved route 68 is formed in a rear portion of the internal space 13 of the casing 14. The second curved route 68 extends rearward and upward from the rear end of the extending route 67, makes a U-turn from the rear side toward the front side, and reaches the opening 150. The first end of the second curved route 68 leads to or is connected to the rear end of the extending route 67 as described above. The second end of the second curved route 68 leads to or is connected to the opening 150. The second curved route 68 is formed by the guide member 28 and the guide member 29 (an exemplary second guide member) facing each other at the predefined interval.

The guide member 28 is arranged at the rear side of the recording section 24. The guide member 28 has a curved surface 28A that is curved to be convex rearward. The guide member 29 is positioned at the rear side of the guide member 28. The guide member 29 has a curved surface 29A (an exemplary second curved surface) that is curved to be concave rearward.

The curved surface 28A guides the second surface 12B of the sheet 12 conveyed from the platen 42 toward the opening 150. The curved surface 29A guides the first surface 12A of the sheet 12 conveyed from the platen 42 toward the opening 150.

<First Conveyance Roller Pair 54, Second Conveyance Roller Pair 55, Third Conveyance Roller Pair 56>

As depicted in FIG. 2, the first conveyance roller pair 54 is positioned in the extending route 67 of the conveyance route 65 at the front side of the recording section 24. The first conveyance roller pair 54 includes a first conveyance roller 60 and a pinch roller 61 facing each other. The first conveyance roller 60 is driven upon receiving driving force from a motor (not depicted). The pinch roller 61 is driven to rotate along with the rotation of the first conveyance roller 60.

The second conveyance roller pair 55 is positioned in the extending route 67 at the rear side of the recording section 24 (positioned downstream of the first conveyance roller pair 54 in the conveyance orientation 16). The second conveyance roller pair 55 has a second conveyance roller 62 and a spur 63 facing each other. The second conveyance roller 62 is driven upon receiving driving force from a motor (not depicted). The spur 63 is driven to rotate along with the rotation of the second conveyance roller 62.

The third conveyance roller pair 56 is positioned in the vicinity of the opening 150 in the second curved route 68. The third conveyance roller pair 56 has a third conveyance roller 57 and a spur 58 facing each other. The third conveyance roller 57 is driven upon receiving driving force from a motor (not depicted). The spur 58 is driven to rotate along with the rotation of the third conveyance roller 57.

Driving force may be transmitted from the same motor or different motors to the first conveyance roller 60, the second conveyance roller 62, the third conveyance roller 57, and the feed roller 25.

The first conveyance roller pair 54, the second conveyance roller pair 55, and the third conveyance roller pair 56 convey the sheet 12 in the conveyance orientation 16 while nipping the sheet 12. That is, the first conveyance roller pair 54 conveys the sheet 12 toward the platen 42, the second conveyance roller pair 55 conveys the sheet 12 toward the third conveyance roller pair 56, and the third conveyance roller pair 56 discharges the sheet 12 through the opening 150.

The sheet 12 supported by the feed tray 20 is fed to the first curved route 66 by the feed roller 25, and the sheet 12 is conveyed toward the first conveyance roller pair 54 along the first curved route 66. When the leading end (downstream end in the conveyance orientation 16) of the sheet 12 has reached the first conveyance roller pair 54, the first conveyance roller pair 54 nips the sheet 12 and conveys the sheet 12 in the conveyance orientation 16 (rearward) along the extending route 67. When the leading end of the sheet 12 has reached the second conveyance roller pair 55, the second conveyance roller pair 55 nips the sheet 12 and conveys the sheet 12 in the conveyance orientation 16 along the second curved route 68. When the leading end of the sheet 12 has reached the third conveyance roller pair 56, the third conveyance roller pair 56 nips the sheet 12 and conveys the sheet 12 in the conveyance orientation 16 (frontward). The sheet 12 conveyed by the third conveyance roller pair 56 is discharged from the opening 150 to the inclined wall 148 of the upper wall 143 of the casing 14. That is, the sheet 12 conveyed by the third conveyance roller pair 56 is discharged from the rear side to the front side through the opening 150. When another sheet 12 is subsequently discharged on the inclined wall 148 in a state where the sheet 12 discharged first is on the inclined wall 148, the another sheet 12 discharged later is put on the sheet 12 discharged first on the inclined wall 148.

<Recording Section 24>

As depicted in FIG. 2, the recording section 24 is positioned above the feed tray 20 to face the extending route 67 of the conveyance route 65 from above. In this embodiment, the recording section 24 is positioned between the first conveyance roller pair 54 and the second conveyance roller pair 55 in the extending route 67.

The recording section 24 is provided above the platen 42 to face the platen 42. The platen 42 is positioned below the extending route 67. That is, the platen 42 is arranged between the recording section 24 and the feed tray 20 in the up-down direction 7. The platen 42 supports the first surface 12A of the sheet 12 from below.

The recording section 24 includes a carriage 23 and a head 39.

As depicted in FIG. 3, an ink tube 32 (an exemplary tube) extends from the carriage 23. Ink stored in the tank 30 is supplied to the head 39 via the ink tube 32.

The carriage 23 is movably supported by the guide rails 43 and 44 forming a part of the frame of the printer 10. The guide rails 43 and 44 are arranged apart from each other in the front-rear direction 8. The guide rail 43 (an exemplary support member) is positioned at the front side of the head 39. The guide rail 44 is positioned at the rear side of the head 39. The guide rails 43 and 44 extend in the left-right direction 9. The carriage 23 is coupled to a publicly-known belt mechanism (not depicted) provided in the guide rail 43 or 44. The belt mechanism performs rotary motion upon receiving driving force from a carriage driving motor (not depicted). The rotary motion of the belt mechanism moves the carriage 23 in the left-right direction 9.

The carriage 23 is movable in the left-right direction 9 beyond the extending route 67. In other words, the carriage 23 is movable between a right-outside position at the right side of the extending route 67 (a position indicated by a broken line in FIG. 3) to a left-outside position at the left side of the extending route 67 (a position depicted by a dot-dash chain line in FIG. 3).

As depicted in FIG. 2, the head 39 is carried on the carriage 23. The head 39 includes a subtank (not depicted), nozzles 40, ink channels (not depicted), and piezoelectric elements (not depicted).

Ink is supplied from the tank 30 to the subtank via the ink tube 32. The nozzles 40 are opened in a lower surface of the head 39. The ink channels connect the subtank and the nozzles 40. Each piezoelectric element deforms a part of the corresponding ink channel, thereby discharging ink droplets from the corresponding nozzle 40. Each piezoelectric element operates when power is fed thereto by a controller (not depicted) for controlling operation of the printer 10. Ink droplets are discharged from the nozzles 40 through the operation of the piezoelectric elements. Ink droplets are discharged from the head 39 onto the sheet 12 supported by the platen 42 during movement of the carriage 23. An image is thus recorded on the sheet 12.

<Sensor 120>

As depicted in FIG. 2, the sensor 120 is positioned in the first curved route 66 of the conveyance route 65. The sensor 120 detects the absence or presence of the sheet 12 at an arrangement position of the sensor 120, and any publicly-known sensor can be adopted. The sheet 12 fed by the feed roller 25 passes through the arrangement position of the sensor 120 and reaches the first conveyance roller pair 54. The sensor 120 outputs one of a high-level signal and a low-level signal (low-level signal in this embodiment) to the controller when the sheet 12 is present at the arrangement position. The sensor 120 outputs the other of the high-level signal or the low-level signal (high-level signal in this embodiment) to the controller when no sheet 12 is present at the arrangement position.

<Rotary Encoder 121>

As depicted in FIG. 2, the printer 10 includes a publicly-known rotary encoder 121 that generates a pulse signal depending on a rotation amount of the first conveyance roller 60. The rotary encoder 121 includes an encoder disk 123 and an optical sensor 124. The encoder disk 123 is attached to the first conveyance roller 60, and rotates along with the rotation of the first conveyance roller 60. The optical sensor 124 reads the encoder disk 123 rotating to generate the pulse signal, and outputs the pulse signal generated to the controller. The controller determines the rotation amount of the first conveyance roller 60 based on the pulse signal received. That is, the rotary encoder 121 measures the rotation of the first conveyance roller 60. The controller determines the position of the sheet 12 in the conveyance route 65 based on the signal output from the sensor 120 and the pulse signal output from the rotary encoder 121.

As depicted in FIG. 3, the encoder disk 123 is attached to a right end of the first conveyance roller 60. The right end of the first conveyance roller 60 is positioned at the right side of the platen 42. That is, the encoder disk 123 is arranged at the right side of the right end of the platen 42. The encoder disk 123 may be arranged at the left side of the left end of the platen 42.

<Tank 30>

The tank 30 indicated by broken lines in FIG. 1 is a container storing ink. The tank 30, which has a rectangular parallelepiped shape, has an internal space. Ink is stored in the internal space. The shape of the tank 30, however, is not limited to the rectangular parallelepiped shape.

In this embodiment, one tank 30 is installed in the installation section 110. The color of ink stored in the one tank 30 is black. The color of ink stored in the tank 30 may be any other color than black.

As depicted in FIGS. 1 and 3, the tank 30 is arranged in the installation section 110. The installation section 110 is positioned below the guide rail 43. In order to depict this positional relationship, a part of the installation section 110 overlapping with the guide rail 43 is indicated by broken lines in FIG. 3.

As depicted in FIG. 3, the installation section 110 is positioned at the right side of the platen 42. More specifically, the installation section 110 is arranged at the right side of the right end of the platen 42. That is, the tank 30 and the encoder disk 123 are positioned at the right side of the platen 42. In other words, the tank 30 and the encoder disk 123 are positioned in a space at the same side (a space at the right side of the platen 42 in this embodiment) from among two spaces positioned at outer sides of the platen 42 in the left-right direction 9. That is, the tank 30 and the encoder disk 123 are positioned at one side of the platen 42 in the left-right direction 9. The installation section 110 may be arranged at the left side of the platen 42.

The installation section 110 and the tank 30 are positioned at the outside in the left-right direction 9 of the encoder disk 123. In this embodiment, the installation section 110 and the tank 30 are positioned at the right side of the encoder disk 123. When the installation section 110 and the encoder disk 123 are positioned at the left side of the conveyance route 65, the installation section 110 and the tank 30 are positioned at the left side of the encoder disk 123. That is, the encoder disk 123 is positioned between the platen 42, and the installation section 110 and the tank 30 in the left-right direction 9.

A rear portion of the tank 30 is positioned to overlap with the encoder disk 123 when seen from the left-right direction 9. The present disclosure, however, is not limited thereto. Instead of the rear portion of the tank 30, a front portion of the tank 30, the whole of the tank 30, or the like may overlap with the encoder disk 123 when seen from the left-right direction 9. That is, at least a part of the tank 30 overlaps with the encoder disk 123 when seen from the left-right direction 9.

An upper portion of the front wall 31 of the tank 30 is an inclined wall 31A that is inclined upward toward the rear side. The inclined wall 31A is formed having a supply opening 33. The supply opening 33 is positioned at the front side of the first conveyance roller 60. The supply opening 33 is a through hole through which the internal space of the tank 30 communicates with the outside. The supply opening 33 is exposed to the outside in the state where the opening/closing cover 152 is in the open position. Under this state, a bottle storing ink is inserted into the supply opening 33, and ink is supplied from the bottle to the internal space of the tank 30.

The supply opening 33 may be formed in any other part than the inclined wall 31A. For example, the supply opening 33 may be formed in an upper wall of the tank 30. In this case, the bottle can access the supply opening 33 from above. Thus, the opening/closing cover is provided in the upper wall 143 of the casing 14 at a position directly above the supply opening 33.

A discharge opening 36 is formed in a left surface 35A of a left side wall 35 of the tank 30, that is, a lower portion of a surface facing inward in the left-right direction 9. The discharge opening 36 is a through hole through which the internal space of the tank 30 communicates with the outside. The discharge opening 36 is positioned at the front side of the guide rail 43.

A left side wall 111 of the installation section 110 is provided with a circulation pipe 112 (an exemplary connection section). The circulation pipe 112 is positioned at the front side of the encoder disk 123.

The circulation pipe 112 passes through the left side wall 111. An end of the circulation pipe 112 (an inside end of the installation section 110) is connected to the discharge opening 36 of the tank 30. That is, the circulation pipe 112 is provided in the left surface 35A (the surface facing inward in the left-right direction 9 of the tank 30) of the left side wall 35 of the tank 30. The other end of the circulation pipe 112 (an outside end of the installation section 110) is connected to the ink tube 32. This allows the internal space of the tank 30 to communicate with the ink tube 32 via the circulation pipe 112.

In this embodiment, the circulation pipe 112 is an exemplary connection section. The connection section, however, is not limited to the circulation pipe 112. A member or a part that has a function of connecting the tank 30 and ink tube 32 may be used as the connection section.

<Ink Tube 32>

As depicted in FIG. 3, a first end 32A of the ink tube 32 is connected to the tank 30 via the circulation pipe 112. A second end 32B of the ink tube 32 is connected to the recording section 24. Specifically, the second end 32B of the ink tube 32 is connected to the subtank of the head 39 and the nozzles 40 of the head 39 via the ink channels.

The ink tube 32 is arranged to extend upward from the circulation pipe 112 and changes its extending direction to the rear side at a position above the guide rail 43. Then, the ink tube 32 is arranged to extend leftward at a position above an upper surface of the guide rail 43. The ink tube 32 is fixed to the guide rail 43 by a fixing section 47 provided at a center portion in the left-right direction 9 of the upper surface of the guide rail 43. In this embodiment, the fixing section 47 is a clip. As the fixing section 47, it is possible to adopt a variety of publicly-known configurations, for example, a configuration using a member that fixes the ink tube 32 while sandwiching the ink tube 32 between the guide rail 43 and itself.

A part of the ink tube 32 ranging from the fixing section 47 to the recording section 24 is arranged to make substantially a U-shape so that the part extends leftward from the fixing section 47 and curves rightward without being fixed to any other member. Thus, the part of the ink tube 32 ranging from the fixing section 47 to the recording section 24 can bend freely without being fixed to any other member in the casing 14. The posture of the part changes depending on the movement of the carriage 23 in the left-right direction 9.

A part extending in the left-right direction 9 of the ink tube 32 arranged above the upper side of the guide rail 43 passes through a predefined space 14A of the casing 14 (see FIG. 2) and is connected to the recording section 24. As depicted in FIG. 2, the predefined space 14A is included in the internal space 13 of the casing 14 and positioned at the front side of the recording section 24.

The ink tube 32 is positioned at the rear side of the upper end 66C (see FIG. 2) of the first curved route 66. In FIG. 3, the upper end 66C is indicated by a long dashed double-dotted line. Th ink tube 32 is connected to the recording section 24 without passing at the front side of the upper end 66C of the first curved route 66. That is, in this embodiment, the predefined space 14A is included in the internal space 13 of the casing 14, positioned at the front side of the recording section 24, and positioned at the rear side of the upper end 66C of the first curved route 66. The predefined space 14A may include the front side of the upper end 66C of the first curved route 66.

<Maintenance Unit 70>

As depicted in FIG. 3, the printer 10 includes the maintenance unit 70. The maintenance unit 70 performs maintenance of the head 39. More specifically, the maintenance unit 70 executes purge operation for sucking ink and air in the nozzles 40 as well as foreign matters adhering to a surface in which the nozzle 40 are opened (lower surface of the head 39). In the following, the ink and air in the nozzles 40 as well as the foreign matters adhering to the nozzle surface are referred to as “ink and the like”. The ink and the like sucked and removed by the maintenance unit 70 are held by a waste liquid tank 74.

The maintenance unit 70 is arranged below a moving route of the carriage 23. The maintenance unit 70 is arranged outside the platen 42 and the guide member 18 in the left-right direction 9. In embodiment, the maintenance unit 70 is arranged at the right side of right ends of the platen 42 and the guide member 18. The maintenance unit 70, however, may be arranged at the left side of left ends of the platen 42 and the guide member 18. The maintenance unit 70 is arranged at the rear side of the first conveyance roller 60.

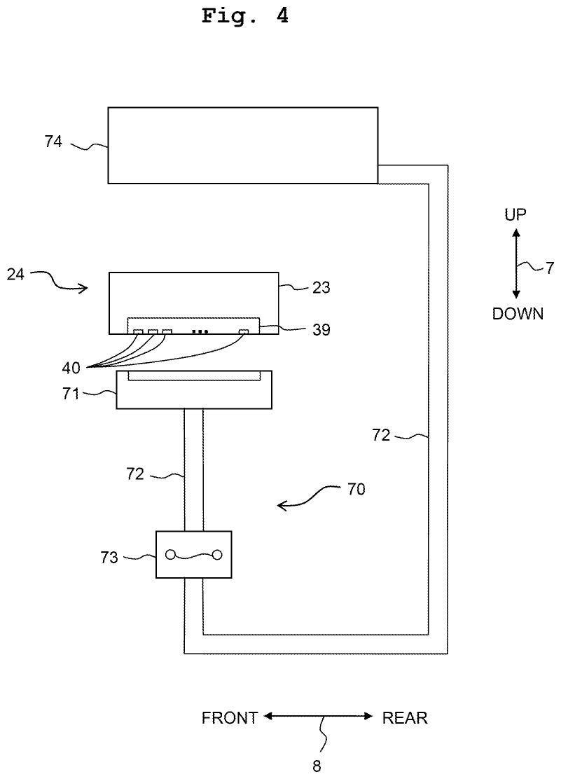

As depicted in FIG. 4, the maintenance unit 70 includes a cap 71, a tube 72, and a pump 73.

The cap 71 is formed by rubber. The cap 71 faces the head 39 in a state where the carriage 23 is positioned at the right outside position (see FIG. 3). The tube 72 extends from the cap 71 and reaches the waste liquid tank 74 via the pump 73. The pump 73 is a rotary-type tube pump. The pump 73 is driven by a motor (not depicted) to suck the ink and the like in the nozzles 40 through the cap 71 and the tube 72 and to discharge them to the waste liquid tank 74 through the tube 72. That is, the cap 71 receives the ink discharged from the head 39 and the liquid received by the cap 71 is discharged to the waste liquid tank 74.

For example, the cap 71 is configured to be movable between a covering position and a separate position apart from each other in the up-down direction 7. The cap 71 in the covering position covers the lower surface of the head 39 by being brought into contact with the head 39 carried on the carriage 23 in the right outside position. That is, the cap 71 in the covering position covers the nozzles 40 from below. This protects the nozzles 40 that are opened in the lower surface of the head 39. On the other hand, the cap 71 in the separate position is separated from the lower surface of the head 39. FIG. 4 depicts the cap 71 in the separate position. The cap 71 moves between the covering position and the separate position by a lifting mechanism (not depicted) that is driven by a motor (not depicted).

As depicted in FIG. 3, the waste liquid tank 74 is arranged at the rear side of the maintenance unit 70. That is, the waste liquid tank 74 is arranged at the right side of the right ends of the platen 42 and the guide member 18. The waste liquid tank 74 may be arranged at the left side of the left ends of the platen 42 and the guide member 18.

<Ink Receiver 92>

As depicted in FIG. 3, the printer 10 includes the ink receiver 92. The ink receiver 92 is arranged below the moving route of the carriage 23. The ink receiver 92 is arranged outside the platen 42 and the guide member 18 in the left-right direction 9. In this embodiment, the ink receiver 92 is arranged at the left side of the left ends of the platen 42 and the guide member 18. The present disclosure, however, is not limited thereto. The ink receiver 92 may be arranged at the right side of the platen 42 and the guide member 18.

The ink receiver 92 is a box-shaped member of which upper portion is open. The ink receiver 92 accommodates an ink absorber 93. The ink receiver 92 can hold the ink sucked from the nozzles 40 and absorbed by the ink absorber 93.

The ink receiver 92 faces the head 39 in a state where the carriage 23 is positioned in the left outside position. In the state where the carriage 23 is in the left outside position, the ink absorber 93 receives ink droplets in idle discharge from the nozzles 40. This is called flushing. The ink droplets in the idle discharge from the head 39 are absorbed by the ink absorber 93 and held by the ink receiver 92.

### Effects of Embodiments

According to this embodiment, the sheet 12 is discharged from the rear side to the front side in the front-rear direction 8. The leading end of the sheet 12 is thus a front end of the sheet 12, which is positioned close to a user who is in front of the printer 10. This makes it possible for the user to take out the discharged sheet 12 easily.

In this embodiment, the inclined wall 148 inclined upward toward the front side makes the space in which the recording section 24 and the ink tube 32 are arranged, larger in the up-down direction 7 toward the front side. In this embodiment, the ink tube 32 is arranged to pass through the predefined space 14A positioned at the front side of the recording section 24, and thus the ink tube 32 can be arranged without the increase in size of the printer 10.

When the recording section 24 is separated from the tank 30 in the left-right direction 9, the ink tube 32 ranging from the tank 30 to the recording section 24 is arranged to extend in the left-right direction 9. It is assumed that the tank 30 is positioned at the side of the right end of the platen 42 in the left-right direction 9 and that the encoder disk 123 is positioned at the side of the left end of the platen 42 in the left-right direction 9. In this case, the ink tube 32 extending in the left-right direction 9 may interfere with the encoder disk 123. However, in this embodiment, since the tank 30 and the encoder disk 123 are positioned at the side of the right end of the platen 42 in the left-right direction 9, such interference is not likely to be caused.

Further, it is assumed that the tank 30 is positioned between the platen 42 and the encoder disk 123 in the left-right direction 9. In this case, the tank 30 may be arranged at the front side of the first conveyance roller 60 to avoid the first conveyance roller 60, which may make the printer 10 large in the front-rear direction 8. In this embodiment, however, the encoder disk 123 is positioned between the platen 42 and the tank 30 in the left-right direction 9, and thus it is possible to inhibit the increase in size of the printer 10 in the front-rear direction 8.

Further, it is assumed that the circulation pipe 112 is positioned at the rear side of the encoder disk 123. In this case, the circulation pipe 112 is positioned between the recording section 24 and the first conveyance roller 60. This makes an interval between the recording section 24 and the first conveyance roller 60 in the front-rear direction 8 large. As a result, there is a high possibility that the sheet 12 is obliquely conveyed toward the recording section 24 by the first conveyance roller 60. In this embodiment, however, the circulation pipe 112 is positioned at the front side of the encoder disk 123. This can shorten the interval between the recording section 24 and the first conveyance roller 60 in the front-rear direction 8, making it possible to reduce the possibility that the sheet 12 is conveyed obliquely.

In this embodiment, the circulation tube 112 is provided in the left surface 35A of the tank 30, and thus the ink tube 32 can be easily arranged to extend in the left-right direction 9.

In this embodiment, the tank 30 is arranged to overlap with the encoder disk 123 when seen from the left-right direction 9, and thus it is possible to inhibit the increase in size of the printer 10 in the front-rear direction 8 and the up-down direction 7.

In this embodiment, the posture of the ink tube 32 arranged in the printer 10 can be stabilized by the fixing section 47. This stabilizes the posture of the head 39, thus inhibiting a situation in which the posture of the head 39 becomes imbalanced during printing. As a result, it is possible to inhibit printing failure or the like.

In this embodiment, the curved surface 18A is curved to convex upward, and thus a space above an upper end of the curved surface 18A is narrow in the up-down direction 7. In this embodiment, however, the ink tube 32 can be arranged without passing through this narrow portion.

### Modified Embodiments

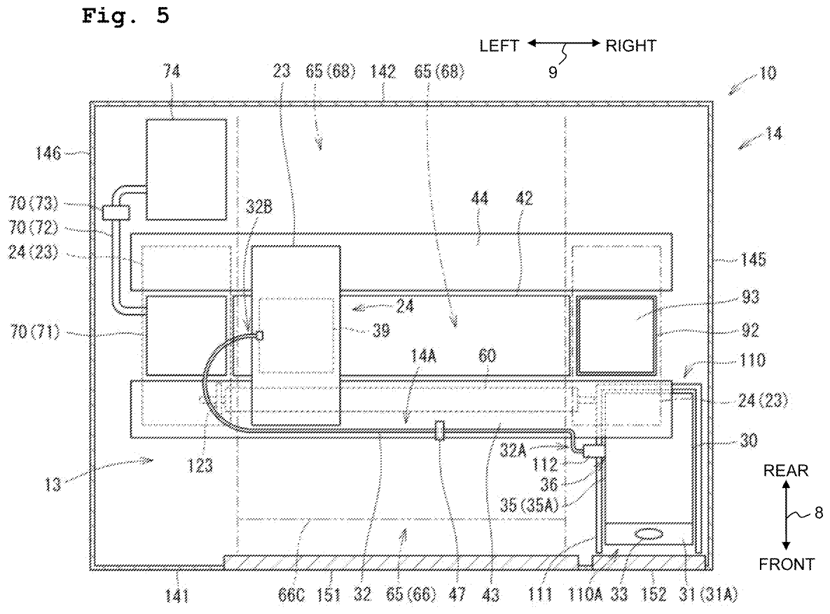

In the above embodiment, the encoder disk 123 and the tank 30 are positioned at the right side of the right end of the platen 42, that is, at the same side in the left-right direction 9 with respect to the platen 42. However, the encoder disk 123 and the tank 30 may be arranged at different sides in the left-right direction 9 with respect to the platen 42. For example, as depicted in FIG. 5, the tank 30 may be arranged at the right side of the right end of the platen 42, and the encoder disk 123 may be arranged at the left side of the left end of the platen 42.

In the above embodiment, the maintenance unit 70 and the tank 30 are arranged at the right side of the right end of the platen 42, that is, at the same side in the left-right direction 9 with respect to the platen 42. However, the maintenance unit 70 and the tank 30 may be arranged at different sides in the left-right direction 9 with respect to the platen 42. For example, as depicted in FIG. 5, the tank 30 may be arranged at the right side of the right end of the platen 42, and the maintenance unit 70 may be arranged at the left side of the left end of the platen 42. In this case, the waste liquid tank 74 is preferably arranged at the left side of the left end of the platen 42, similar to the maintenance unit 70. Further, in this case, the ink receiver 92 is preferably arranged at a side opposite to the maintenance unit 70 in the left-right direction 9, that is, at the right side of the right end of the platen 42.

In the configuration depicted in FIG. 5, when the recording section 24 is positioned directly above the cap 71, the ink tube 32 can be easily arranged without passing directly above the platen 42. Since the ink tube 32 is not directly above the platen 42, a user can easily access and take out the sheet 12 jammed between the platen 42 and the recording section 24 from above.

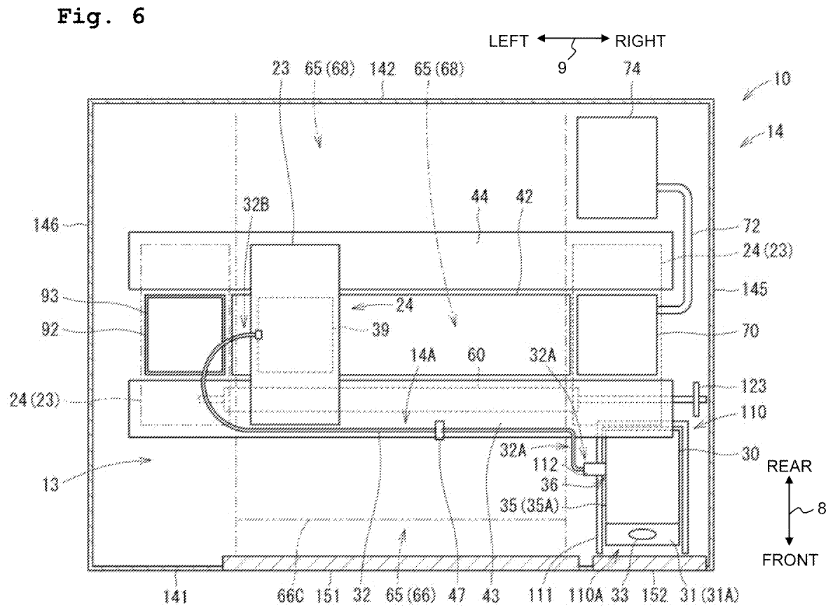

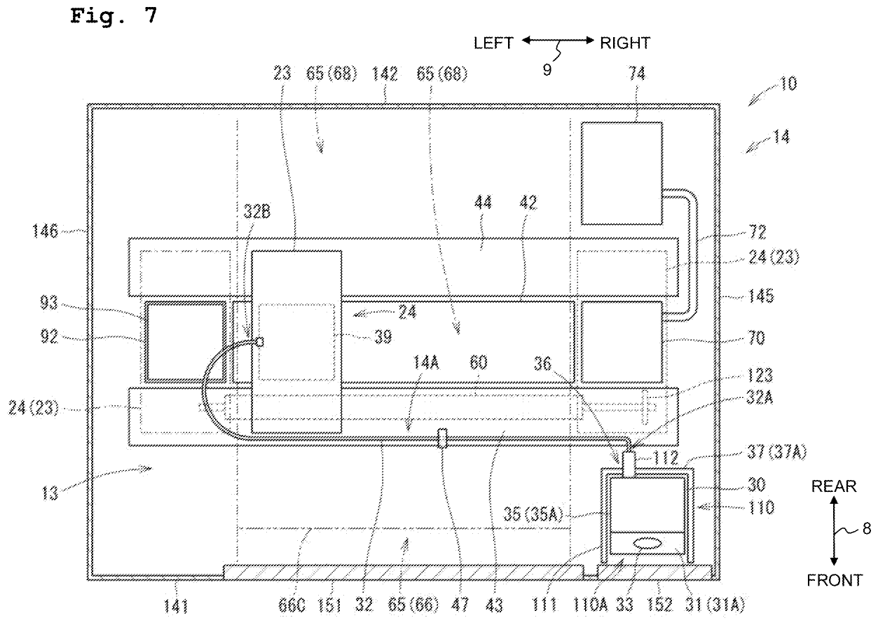

In the above embodiment, the tank 30 is positioned at the right side of the encoder disk 123, that is outside the encoder disk 123 in the left-right direction 9. However, the tank 30 may be arranged inside the encoder disk 123 in the left-right direction 9 as depicted in FIG. 6, or the tank 30 and the encoder disk 123 may be arranged at the same position in the left-right direction 9 as depicted in FIG. 7. As depicted in FIG. 7, when the tank 30 and the encoder disk 123 are arranged at the same position in the left-right direction 9, a center portion in the left-right direction 9 of the tank 30 may be positioned to overlap with the encoder disk 123 when seen from the front-rear direction 8. A part of the tank 30 overlapping with the encoder disk 123 when seen from the front-rear direction 8 is not limited to the center portion in the left-right direction 9 of the tank 30. For example, a right portion of the tank 30 or the whole of the tank 30 may overlap with the encoder disk 123 when seen from the front-rear direction 8. That is, at least a part of the tank 30 is positioned to overlap with the encoder disk 123 when seen from the front-rear direction 8.

According to the configurations depicted in FIGS. 6 and 7, it is possible to inhibit the increase in size of the printer 10 in the left-right direction 9 and the up-down direction 7.

In the above embodiment, the circulation pipe 112 is positioned at the front side of the encoder disk 123. However, the circulation pipe 112 may be positioned at the rear side of the encoder disk 123, or the circulation pipe 112 and the encoder disk 123 may be arranged at the same position in the front-rear direction 8.

In the above embodiment, at least a part of the tank 30 is positioned to overlap with the encoder disk 123 when seen from the left-right direction 9. However, the tank 30 may not overlap with the encoder disk 123 when seen from the left-right direction 9. For example, as depicted in FIGS. 6 and 7, the tank 30 may be positioned at the front side of the front end of the encoder disk 123.

It is assumed that the tank 30 is positioned at the rear side of the encoder disk 123. In this case, the tank 30 may be arranged outside the first conveyance roller 60 in the left-right direction 9 in order to avoid the first conveyance roller 60. This may cause the increase in size of the printer 10 in the left-right direction 9. In the configurations depicted in FIGS. 6 and 7, however, the tank 30 is positioned at the front side of the encoder disk 123. This inhibits the increase in size of the printer 10 in the left-right direction 9.

In the above embodiment, the discharge opening 36 of the tank 30 is formed in the left side wall 35 of the tank 30. The discharge opening 36, however, may be formed in any other part than the left side wall 35.

For example, as depicted in FIG. 7, the discharge opening 36 may be formed in a rear surface 37A (a surface facing rearward) of the rear wall 37 of the tank 30. Although the discharge opening 36 may be arranged in any position in the left-right direction 9 in the rear wall 37, the discharge opening 36 is positioned between the platen 42 and the encoder disk 123 in the left-right direction 9 in FIG. 7. This can shorten the ink tube 32 in the left-right direction 9.

When the discharge opening 36 and the circulation pipe 112 are provided in the rear surface 37A of the tank 30, the encoder disk 123 is arranged closer to the discharge opening 36 and the circulation pipe 112 in the front-rear direction 8 than the case depicted in FIG. 7. This makes it possible to arrange at least a part of the encoder disk 123 at a position overlapping with the circulation pipe 112 when seen from the left-right direction 9. As a result, the increase in size of the printer 10 in the front-rear direction 8 can be inhibited.

In the above embodiment, the opening/closing cover 152 is provided at the right side of the opening/closing cover 151, that is, in the right portion of the front wall 141. The installation section 110 is provided in the right front portion of the internal space 13 of the casing 14. However, the opening/closing cover 152 may be provided in any other portion than the right side of the opening/closing cover 151. For example, the opening/closing cover 152 may be provided at the left side of the opening/closing cover 151, that is, in the left portion of the front wall 141. In this case, the installation section 110 is provided in a left front portion of the internal space 13 of the casing 14. Or, the opening/closing cover 152 may be provided in any other portion than the front wall 141 of the casing 14. For example, the opening/closing cover 152 may be provided in the right wall 145 of the casing 14. In this case, the installation section 110 is provided in a right portion of the internal space 13 of the casing 14.

In the above embodiment, one tank 30 is arranged in the installation section 110. That is, the printer 10 includes one tank 30. The printer 10, however, may include multiple tanks 30.

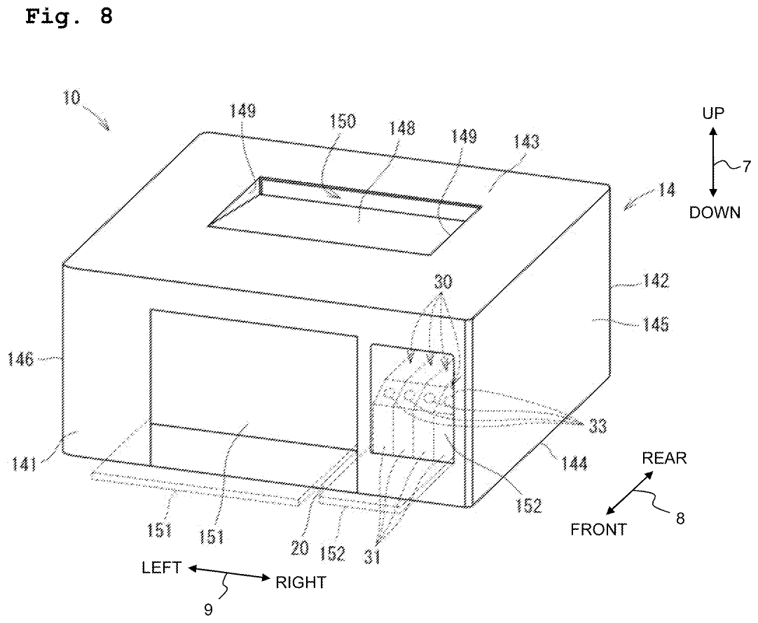

For example, as depicted in FIG. 8, the printer 10 may include the tanks 30. In this case, the installation section 110 is configured so that the tanks 30 can be installed therein. Although four tanks 30 are installed in the installation section 110 in FIG. 8, the number of tanks 30 installed in the installation section 110 is not limited to four. In FIG. 8, the four tanks 30 respectively contain inks of black, cyan, magenta, and yellow. The colors of inks stored in the tanks 30 are not limited to those.

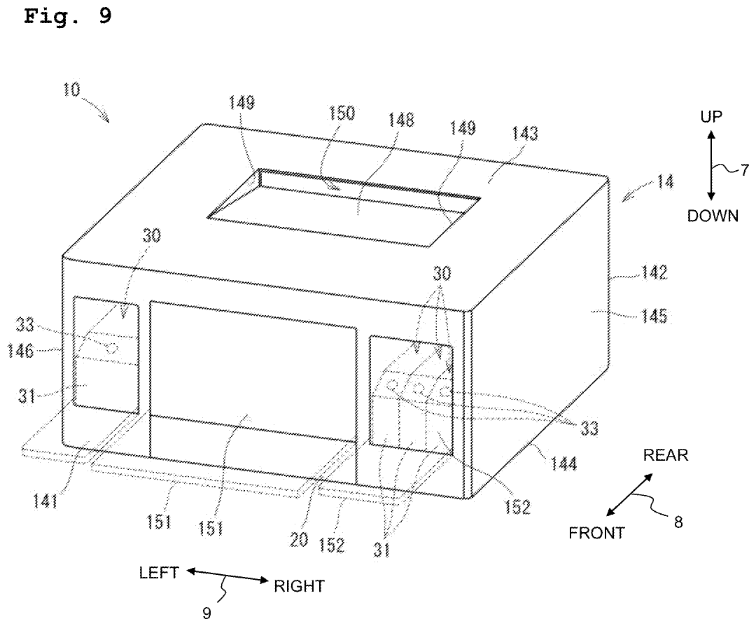

For example, the printer 10 may include multiple installation sections 110. Each of the installation sections 110 may be configured so that at least one tank 30 can be installed therein. In this case, as depicted in FIG. 9, each of the opening/closing covers 152 is provided at the corresponding one of the right and left sides of the opening/closing cover 151. The installation sections 110 are provided at the rear side of the two opening/closing covers 152. The installation section 110 positioned at the rear side of the right opening/closing cover 152 is configured so that the tank 30 containing black ink can be installed therein. The installation section 110 positioned at the rear side of the left opening/closing cover 152 is configured so that three tanks 30 respectively containing cyan, magenta, and yellow inks can be installed therein. However, the number of the opening/closing covers 152, the number of the installation sections 110, the number of the tanks 30 installed in each installation section 110, and the colors of ink stored in the tanks 30 are not limited to the above.

In the above embodiment, the tank 30 is a reservoir of the present disclosure. The tank 30 is installed in the installation section 110. When a remaining amount of ink in the tank 30 is small, ink is supplied through the supply opening 33. However, the reservoir is not limited to the tank 30. For example, the reservoir may be an ink cartridge storing ink. The ink cartridge may be inserted into and removed from the installation section 110. When a remaining amount of ink in the ink cartridge is small, the ink cartridge is removed from the installation section 110 and a new ink cartridge storing a large amount of ink is inserted into and installed in the installation section 110.

What is claimed is:

1. An ink-jet printer, comprising:
a tray configured to support a sheet;
a recording section including a carriage positioned above the tray and configured to move in a width direction orthogonal to an up-down direction and a front-rear direction, and a head carried on the carriage and including a nozzle configured to discharge an ink droplet;
a reservoir configured to store an ink;
a tube connecting the reservoir and the recording section;
a platen located between the recording section and the tray in the up-down direction, and configured to support a first surface of the sheet that is conveyed, below the head, from a front side toward a rear side in the front-rear direction;
a first guide member arranged at the front side of the recording section and including a first curved surface configured to guide the first surface of the sheet conveyed from the tray toward the platen;
a discharge section configured to discharge the sheet having an image recorded by the recording section from the rear side toward the front side in the front-rear direction, the discharge section being arranged at the rear side of the recording section;
a second guide member arranged at the rear side of the recording section and having a second curved surface configured to guide the first surface of the sheet conveyed from the platen toward the discharge section; and
a loading section configured to load the sheet discharged from the discharge section thereon, at least a part of the loading section being positioned above the recording section,
wherein the loading section includes an inclined portion at the rear side of the recording section, the inclined portion being inclined upward toward the front side of the discharge section, and
wherein the tube passes through a specified space positioned at the front side of the recording section and is connected to the recording section.

2. The ink-jet printer according to claim 1, further comprising an encoder disk configured to measure rotation of a conveyance roller configured to convey the sheet,
wherein the reservoir and the encoder disk are positioned at a side of an end in the sheet width direction of the platen.

3. The ink-jet printer according to claim 2, wherein the encoder disk is positioned between the platen and the reservoir in the width direction.

4. The ink-jet printer according to claim 2, wherein the reservoir includes a connection section connected to the tube, and
the connection section is positioned at the front side of the encoder disk.

5. The ink-jet printer according to claim 4, wherein the connection section is provided in a surface facing inward in the width direction of the reservoir.

6. The ink-jet printer according to claim 2, wherein at least a part of the reservoir is arranged to overlap with the encoder disk in the width direction.

7. The ink-jet printer according to claim 2, wherein the reservoir is positioned at the front side of the encoder disk.

8. The ink-jet printer according to claim 7, wherein the reservoir includes a connection section connected to the tube, and
the connection section is positioned between the platen and the encoder disk in the width direction.

9. The ink-jet printer according to claim 8, wherein the connection section is provided in a surface facing rearward of the reservoir.

10. The ink-jet printer according to claim 7, wherein at least a part of the reservoir is arranged to overlap with the encoder disk in the front-rear direction.

11. The ink-jet printer according to claim 1, further comprising a cap configured to come into contact with the head such that the cap covers the nozzle,
wherein the reservoir is positioned at a side of a first end in the sheet width direction of the platen, and
the cap is positioned at a side of a second end in the width direction of the platen.

12. The ink-jet printer according to claim 1, further comprising a support member configured to support the carriage so that the carriage is movable, and
wherein the support member includes a fixing section configured to fix the tube.

13. The ink-jet printer according to claim 1, wherein the predefined space is a space positioned at the rear side of an upper end of the first curved surface.
